(19) United States
(12) Patent Application Publication
(10) Pub. No.: US 2025/0048416 A1
(43) Pub. Date: Feb. 6, 2025

(54) METHODS AND APPARATUSES FOR RLM FOR INTER-CELL MTRP OPERATION

(71) Applicant: TELEFONAKTIEBOLAGET LM ERICSSON (PUBL), Stockholm (SE)

(72) Inventors: Helka-Liina MÄÄTTÄNEN, ESPOO (FI); Icaro Leonardo Da Silva, SOLNA (SE); Pradeepa Ramachandra, LINKÖPING (SE); Venkatarao GONUGUNTLA, Sundbyberg (SE)

(21) Appl. No.: 18/696,210

(22) PCT Filed: Sep. 30, 2022
(86) PCT No.: PCT/IB2022/059353

§ 371 Date: Mar. 27, 2024

(30) Foreign Application Priority Data
Oct. 1, 2021 (IN) 202111044711

(51) Int. Cl. H04W 72/542; H04L 5/00; H04W 24/04; H04W 76/19

(52) U.S. Cl. CPC H04W 72/542; H04L 5/0035; H04L 5/0051; H04L 5/0053; H04W 24/04; H04W 76/19

(57) ABSTRACT

There is provided a method performed by a user equipment (UE). The method comprises: receiving a message for activating multiple Transmission Configuration Indicators (TCIs) configured for the UE; and performing Radio Link Monitoring (RLM) measurements, for a plurality of Transmission Reception Points (TRPs) configured for the UE, on reference signals associated with multiple Physical Cell Identifiers (PCIs), wherein the reference signals are configured as Quasi-Colocation (QCL) source of the activated TCI states. A UE for implementing this method is also provided.

### RELATED APPLICATIONS

This application claims the benefits of Patent Application No. 202111044711, entitled “RLM for inter-cell mTRP operation” and filed at the Indian Patent Office on Oct. 1, 2021, the content of which is incorporated herein by reference.

### BACKGROUND

### Radio Link Monitoring (RLM) Handling in New Radio (NR)

In NR, RLM is defined for a similar purpose as in Long Term Evolution (LTE), i.e. monitor the downlink (DL) radio link quality of the serving cell (more precisely the special Cell (SpCell), i.e. primary cell (PCell) and primary secondary (PSCell) if the User Equipment (UE) is configured with Multiple-Radio Dual Connectivity (MR-DC)) in RRC_CONNECTED state.

RLM is performed by the lower layers at the UE (L1—layer 1, physical layer). The UE performs measurements (e.g. Signal to Interference and Noise Ratio (SINR)) of a reference signal/cell. When the quality of the reference signal/cell is poor (according to a hypothetical Physical Downlink Control Channel (PDCCH) Block Error Rate (BER) threshold), the lower layers at the UE generate an out of sync (OOS) indication to a higher layer, which maintains a counter. Similarly, when the quality improves (according to another hypothetical PDCCH BER threshold), the UE generates an in sync (IS) indication to the higher layer, which maintains another counter. These counters are used by the higher layer to determine whether or not a radio link failure (RLF) should be declared.

To perform these measurements to generate OOS and IS events, the UE uses reference signals (RSs). In LTE, these are the so-called Cell-specific Reference Signals (CRS) defined per cell. Different from LTE, some level of configurability has been introduced for RLM in NR in terms of RS type/beam/RLM resource configuration and BLER thresholds for IS/OOS generation.

### Explicit RLM Configuration

In NR, two types of reference signals (RS Types) are defined for Layer 3 (L3) mobility: Physical Broadcast Channel (PBCH)/Synchronization Signal (SS) Block (SSB or SS Block), which basically comprises synchronization signals equivalent to Primary SS (PSS)/Secondary SS (SSS) in LTE and PBCH/Demodulation Reference Signal (DMRS), and, Channel State Information (CSI)-RS for L3 mobility, more configurable and configured via dedicated signaling. There are different reasons to define the two RS types, one of them being the possibility to transmit SSBs in wide beams, while CSI-RSs are transmitted in narrow beams.

In NR, the RS type used for RLM is also configurable and both CSI-RS based RLM and SS block based RLM are supported. In the case of CSI-RS, the time/frequency resource and sequence can be used. As there can be multiple beams, the UE needs to know which ones to monitor for RLM and how to generate IS/OOS events. In the case of SSB, each beam can be identified by an SSB index (derived from a time index in PBCH and/or a PBCH/DMRS scrambling). The network can configure by RRC signalling, X RLM resources, either related to SS blocks or CSI-RS, as follows:
One RLM-RS resource can be either one PBCH/SS block or one CSI-RS resource/port;
The RLM-RS resources are UE-specifically configured at least in case of CSI-RS based RLM;
When a UE is configured to perform RLM on one or multiple RLM-RS resource(s),
   Periodic IS is indicated if the estimated link quality corresponding to hypothetical PDCCH BLER based on at least Y RLM-RS resource(s) among all configured X RLM-RS resource(s) is above Q_in threshold;
   Periodic OOS is indicated if the estimated link quality corresponding to hypothetical PDCCH BLER based on all configured X RLM-RS resource(s) is below Q_out threshold;
      That points in the direction that only the quality of best beam really matters at every sample to generate OOS/IS events.

Note: RLM is not defined for SCells, only for SpCells, i.e. if the UE is in single connectivity, RLM is performed only on the PCell. If the UE is configured with MR-DC, RLM is performed on both the PCell and the PSCell.

Resources for RLM can be configured via RRC in TS 38.331 as part of the SpCellConfig, within each dedicated Bandwidth Part (BWP) configuration—BWP-DownlinkDedicated, in an RRCReconfiguration or RRCResume message) within the RadioLinkMonitoringConfig Information Element (IE).

Each so-called RLM resource of an SpCell that needs to be monitored is configured in the IE RadioLinkMonitoringRS, where the UE is configured either with an SSB index or a CSI-RS index. These resources are equivalent to the downlink beams/spatial directions transmitting the reference signals (e.g. SSBs) associated to these indexes. And each of these beams are also used for transmission of control channel(s) for that cell (e.g. PDCCH) so that performing RLM is equivalent to assess the quality of control channel for that cell.

The UE can be configured with up to N_{RLM} RadioLinkMonitoringRS for RLM depending on Lₘₐₓ (maximum number of SSBs and/or downlink beams transmitting SSBs).

### Implicit RLM Configuration

According to 3GPP TS 38.331, if an explicit list of RSs is not configured for RLM, the UE monitors the RS(s) configured as Quasi-co-location (QCL) of currently active Transmission Configuration indicator (TCI) states configured for the PCell or PSCell. This is described in RRC in the field description below:

RadioLinkMonitoringConfig field descriptions

failureDetectionResourcesToAddModList
A list of reference signals for detecting beam failure and/or
cell level radio link failure (RLF). [ . . . ] If no RSs are
provided in this list for the purpose of RLF detection, the UE
performs Cell-RLM based on the activated TCI-
State of PDCCH as described in TS 38.213 [13], clause 5.
The network ensures that the UE has a suitable set
of reference signals for performing cell-RLM.

As described in TS 38.213, if the UE is not provided with RadioLinkMonitoringRS but the UE is provided, for PDCCH receptions, with TCI states that include one or more of a CSI-RS:
the UE uses for RLM the RS provided for the active TCI states for PDCCH reception, if the active TCI states for PDCCH reception includes only one RS;
if the active TCI states for PDCCH reception include two RS, the UE expects that one RS is configured with qcl-Type set to ‘typeD’[6, TS 38.214] and the UE uses the RS configured with qcl-Type set to ‘typeD’ for RLM; the UE does not expect both RS to be configured with qcl-Type set to ‘typeD’;
the UE is not required to use for RLM an aperiodic or semi-persistent RS;
For Lₘₐₓ=4, the UE selects the N_{RLM} RS provided for the active TCI states for PDCCH receptions in Control Region Sets (CORESETs) associated with the search space sets in an order from the shortest monitoring periodicity. If more than one CORESETs are associated with search space sets having the same monitoring periodicity, the UE determines the order of the CORESET from the highest CORESET index as described in clause 10.

The RS for a TCI state can be configured as CSI-RS or SSB. And the TCI state is considered activated based on reception of Media Access Control (MAC) Control Elements (CEs) (see TS 38.321 for further details on MAC CE activation of TCI states).

### Out of Sync (OOS) and in Sync (IS) Indications Based on RLM Resources

For both implicit and explicit RLM configurations, the UE performs monitoring of the resources and evaluates the conditions whether radio link is suitable for the RRC connection or not.

In non-discontinuous reception (DRX) mode operation, the physical layer in the UE assesses once per indication period the radio link quality, evaluated over the previous time period defined in TS 38.133 against thresholds (Qₒᵤₜ and Qᵢₙ) configured by rlmInSyncOutOfSyncThreshold. The UE determines the indication period as the maximum between the shortest periodicity for RLM resources and 10 msec.

In DRX mode operation, the physical layer in the UE assesses once per indication period the radio link quality, evaluated over the previous time period defined in TS 38.133, against thresholds (Qₒᵤₜ and Qᵢₙ) provided by rlmInSyncOutOfSyncThreshold. The UE determines the indication period as the maximum between the shortest periodicity for RLM resources and the DRX period.

The physical layer in the UE indicates, in frames where the radio link quality is assessed, OOS to higher layers, when the radio link quality is worse than the threshold Qₒᵤₜ for all resources in the set of resources for RLM. When the radio link quality is better than the threshold Qᵢₙ for any resource in the set of resources for RLM, the physical layer in the UE indicates, in frames where the radio link quality is assessed, in-sync to higher layers.

### Radio Link Failure (RLF) Due to Physical Layer Problems

The higher layer (e.g. RRC) receives the OOS and IS indications from the lower layers (L1), as described above. After a configurable number (N310) of such consecutive OOS indications, a timer (T310) is started. If the link quality is not improved (recovered) while T310 is running (i.e. there are no N311 consecutive “in-sync” indications from the physical layer), a RLF is declared in the UE, see FIG. 1, which summarizes the procedure for declaring RLF.

Upon declaring RLF in the PCell, the UE initiates re-establishment or, if configured with MR-DC and if configured with Master Cell Group (MCG) failure reporting, it reports an MCG failure to the PSCell. Upon declaring RLF in the PSCell (also named S-RLF), the UE initiates a Secondary Cell Group (SCG) Failure Report via the PCell.

Multi-Transmission Reception Point (mTRP) in Release (Rel)-16

The general concept of multi-TRP has been standardized in Rel-16, though it has been limited to single cell transmission/reception.

In Rel-16, the concept of multi PDCCH multi-TRP transmission has been introduced together with the concept of CORESET pool index. In the mTRP mPDCCH feature, a UE is configured with a CORESETPoolIndex per CORESET. Thus, the TCI states activated in the CORESETs with the same CORESETPoolIndex are associated to the CORESETPoolIndex. In 3GPP specifications, the CORESETPoolIndex is used to represent a TRP. RLM functionality remains the same, as the whole configuration is still associated to a single SpCell, i.e. RSs for RLM associated with the same SpCell and there is only a single Physical Cell Identity (PCI) for the UE for the two TRPs. FIG. 2 illustrates an example of multi-PDCCH based multi-TRP transmission with a single scheduler.

Inter-Cell Multi-Transmit-Receive Point (mTRP) in Release (Rel)-17

RAN2 confirm the simplified procedures on the inter-cell multi-TRP-like model as a baseline RAN2 understanding:

### Scenario 1: Inter-Cell Multi-TRP-Like Model

1. UE receives from serving cell, configuration of SSBs of the TRP with different PCI for beam measurement, and configurations needed to use radio resources for data transmission/reception incl resources for different PCIs.

2. UE performs beam measurement for the TRP with different PCI and report it to serving cell.

3. Based on the above reports, TCI state(s) associated to the TRP with different PCI is activated from the serving cell (by L1/L2 signaling).

4. UE receives and transmits using UE-dedicated channel on TRP with different PCI.

5. UE should be in coverage of a serving cell always, also for multi-TRP case, e.g. UE should use common channels BCCH PCH etc. from the serving cell (as in legacy).

RAN2 is currently discussing possible RRC models for configuring inter-cell mTRP for Rel-17, which might be also called inter-cell beam management operation. The options for the RRC models are summarized below.

### Option 1: Cell

In this option, TRP with different PCI is defined as an independent cell. The following aspects are summarized based on [R2-2107948], [R2-2108478], [R2-2108632]:
This new cell is always “associated” with a legacy serving cell via the inter-cell mTRP operation. In Rel-17, the two cells share the same frequency.
The secondary TRP cell (Assisting Cell) can have same or different Cell-Radio Network Temporary Identifier (C-RNTI) than the associated primary cell (Main cell).
   The configuration of the secondary TRP cells (Assisting Cell) for addition, modification, and release is done by RRC signaling.
Every legacy serving cell (SpCell or SCell) can have an associated secondary TRP cell.
When Assisting Cell is used for Uplink (UL), Radio Link Management (RLM) should follow Assisting Cell signals (FFS whether this is part of Main cell (legacy serving cell) or as separate Assisting Cell RLM).

There could be different sub-options derived from Option 1, such as the following:
Each inter-cell mTRP configuration has its own ServingCellConfig (so the UE is configured with multiple ServingCellConfig(s), one per TRP) and its own ServingCellConfigCommon (so the UE is configured with multiple ServingCellConfig(s), one per TRP);
Each inter-cell TRP configuration has its own ServingCellConfig (so the UE is configured with multiple ServingCellConfig(s), one per TRP), but there is a single ServingCellConfigCommon, possibly associated to the initial PCell (the PCell the UE initially connects to and/or performs reconfiguration with sync).

### Option 2: BWP

In this option, TRP with different PCI is modelled as additional Bandwidth Part (BWP). The following aspects are summarized based on [R2-2107585] and [R2-2108632]:
Configure the different TRP as the different BWP, and the TRP activation/deactivation can be achieved via the BWP switching mechanism.
The common configuration would be kept for the source cell, i.e. the UE keeps monitoring the source cell's common channel.
For the TRP with different PCI, it has the full set of the PUCCH/PDCCH/PDSCH/PUSCH (PxxCH) configuration, and the full set of common and dedicated configuration. Switching to TRP with different PCI is based on L1 signaling.
   Option 3: Beam Resource (e.g. TCI State, QCL-Info)

In this option, TRP with different PCI is modelled as a dedicated resource to enable separate beam, i.e. separate TCI-state/QCL-information. The following is summarized based on [R2-2107906], [R2-2108632], [R2-2108656], [R2-2108807]:
The additional SSB set(s) from a non-serving cell (TRP with different PCI) is configured within the serving cell configuration and associated with an index. This index can then be used for associating TCI states, Channel State Information (CSI) measurement configurations, potential UL configurations, etc. with the additional SSB set (PCI).
TCI state is also configured in the serving cell configuration but assigned with SSB index associated to the different PCI.
In inter-cell multi-TRP operation, the CORESETPoolIndex with value 0 is associated with the serving cell, while CORESETPoolIndex with value 1 is associated with the non-serving cell.
All other configuration in BWP could be shared by a neighbor cell except for Physical (PHY) dedicated channels (PxxCH).
Cell-specific parameters for neighbor TRPs/Cells are shared with the source cell or cell-specific parameters are not needed on the neighbor TRPs/Cells, e.g. Random Access Channel (RACH) is not needed on the neighbor cell and RACH is triggered by PDCCH-command if needed. It is assumed that Timing Advance is always aligned between source and neighbor cells.
SSB related information of the non-serving PCI is included in the CSI configuration to configure CSI for TRP with different PCI.

One sub-option derived from Option 3 is the following:
The inter-cell mTRP configurations are within a single ServingCellConfig and there is a single ServingCellConfigCommon, even though there may be PCI-specific configurations.

### Option 4: New Structure

In [R2-2107415], a new approach is proposed, in which a new Information Element (IE), e.g. NonServingCellConfig, is defined to include all non-serving cell information (i.e. TRP with different PCI).
Non-serving cell SSB information (at least SSB time domain position, SSB transmission periodicity, SSB transmission power) is needed in inter-cell MTRP operation.
PCI of non-serving cell is included in the new IE (e.g. NonServingCellConfig) for non-serving cell.
An index of non-serving cell with corresponding configurations is introduced to associate with TCI state.

These options describe how the “configurations needed to use radio resources for data transmission reception including resources for different PCIs” is organized within the UEs dedicated RRC configuration. In Options 1 and 2, all physical layer configuration parameters may be set differently among the TRPs while in Option 3, most parameters are shared. Option 4 is ASN1 coding specific hybrid which may coincide with Option 1 or Option 3.

Despite the differences in the RRC model for inter-cell mTRP/inter-cell beam management, what all these options have in common is that the UE is configured with multiple PCI(s) and/or multiple C-RNTI(s), even for the same serving frequency.

Inter-Cell Multi-TRP (mTRP) in Rel-18 and Possibly 6G

In the last Radio Access Network (RAN) plenary meeting, the scope of Rel-18, currently called 5G Advanced is being discussion. Inter-cell beam management is one of the main topics in the area of mobility enhancements. Although it is not clear what exact solution would be adopted in Rel-18 in comparison to Rel-17 inter-cell mTRP, one possible difference is that while in Rel-17 the UE relies on control channels from a single serving cell, while it possibly receives/transmits data from/to other cells (dedicated channels having TCI state whose QCL source is associated with a RS with PCI of that other cell), in Rel-18 it might also be possible to use common channels from these other cells. For example, Rel-17 may end up modeling inter-cell mTRP as in Option 3, while Rel-18 will model the inter-cell mTRP as in Option 1. However, these differences may not be fundamental for the present disclosure, i.e., the present disclosure is likely applicable in Rel-17 scenario, but also in a possible Rel-18 scenario for inter-cell mTRP.

It may happen that 5G evolution topics, e.g. from 5G advanced, become part of the 6G standard. Inter-cell beam management/inter-cell mTRP are topics that may gain some attention in 6G times. And, if one solution is adopted in 5G evolution, another solution may be adopted in 6G.

### SUMMARY

There currently exist certain challenge(s). A Rel-16 UE performs RLM based on one of the following methods:

1) The UE obtains an explicit list of RSs to monitor for the RLM purpose in RadioLinkMonitoringConfig.

2) The UE performs the RLM based on the RS(s) provided as QCL source for the active TCI state for PDCCH receptions.

Inter-cell mTRP adds the notion of multiple PCIs associated to different TRPs the UE is configured with, even for the same serving frequency as the PCell. Depending on the RRC modeling option, the PCI is related to separate cell configurations (Option 1) or within the same cell configuration (Option 3).

The existing RLF reporting is designed for single serving cell/single PCI assumption as that has been the default before the introduction of intercell mTRP. Thus, the configuration of RLM resources and RLF reporting need to be defined.

It is also not clear as to what happens when the UE finds itself in out-of-sync situation based on RLM for a long time, i.e., how the RLM impacts the RLF related operations are yet to be discussed. Further, even for the rel-16 mTRP, the RLF failure report has not been discussed.

Certain aspects of the disclosure and their embodiments may provide solutions to these or other challenges.

Embodiments in this disclosure cover options for RLM resource configuration, timer and counter option, RLM operation and UE actions for a variety of options how intercell mTRP may be modeled and how RLM could be considered for those.

More specifically, the disclosure covers the following aspects related to the RLM configuration and RLM operation when the UE is configured with the inter-cell mTRP operation:
1) Explicit and implicit RLM configuration options;
2) Configuration associated to the respective timers/counters;
3) Performing the RLM by the UE under each RLM configuration option;
4) UE actions upon detecting failure based on RLM operation.

The above spreads into several options and sub-options which may or may not be different depending on RRC modeling option.

In one aspect, there is provided a method in a UE, for performing RLM measurements, in the context of inter-cell mTRP, The method comprises: receiving a message for activating multiple TCIs configured for the UE, and performing RLM measurements, for a plurality of TRPs configured for the UE, on reference signals associated with multiple PCIs, wherein the reference signals are configured as Quasi-Colocation (QCL) source of the activated TCI states. A UE for implementing this method is also provided.

In another aspect, there is provided a method in a network node, in communication with a wireless device/UE for performing RLM measurements in the context of inter-cell mTRP. The method comprises: transmitting a message for activating multiple TCI states configured for a UE, wherein the activated TCI states have references signals configured as QCL source, the configured references signals being associated with multiple PCIs and used for RLM measurements for a plurality of TRPs configured for the UE; and receiving a radio link failure indication for a first PCI from the multiple PCIs, the first PCI being different from a second PCI of a serving cell. A network node for implementing this method is also provided.

Certain embodiments may provide one or more of the following technical advantage(s).

They provide solutions for RLM configurations and operations. For inter-cell mTRP, the RLM is an important consideration as the UE may move among the TRPs and there needs to be good model on how the UE and network keep track that the radio conditions are good enough to support the RRC connection and the UE can still be scheduled and considered RRC connected.

### BRIEF DESCRIPTION OF THE DRAWINGS

Exemplary embodiments will be described in more detail with reference to the following figures, in which:

FIG. 1 illustrates a diagram for Radio Link Failure due to physical layer problems.

FIG. 2 shows an example of multi-PDCCH based multi-TRP transmission with a single scheduler.

FIG. 3 illustrates an exemplary scenario of inter-cell mTRP operation.

FIG. 4 illustrates a flow chart for a method in a UE, according to an embodiment.

FIG. 5 shows a flow chart of a method in a network node, according to an embodiment.

FIG. 6 illustrates a flow chart for a method in a UE, according to an embodiment.

FIG. 7 shows a flow chart of a method in a network node, according to an embodiment.

FIG. 8 shows an example of a communication system, according to an embodiment.

FIG. 9 shows a schematic diagram of a UE, according to an embodiment.

FIG. 10 shows a schematic diagram of a network node, according to an embodiment.

FIG. 11 illustrates a block diagram of a host.

FIG. 12 illustrates a block diagram illustrating a virtualization environment.

FIG. 13 shows a communication diagram of a host.

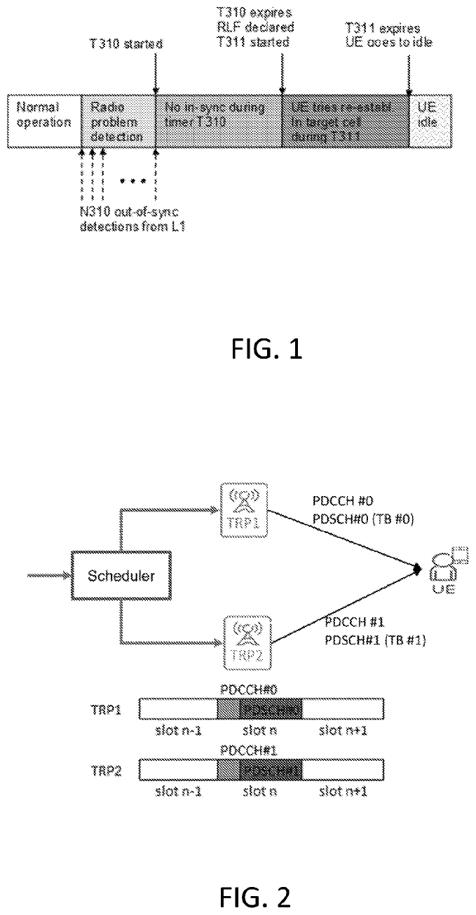

### ADDITIONAL EXPLANATION

Some of the embodiments contemplated herein will now be described more fully with reference to the accompanying drawings. Embodiments are provided by way of example to convey the scope of the subject matter to those skilled in the art.

### Disclaimers

The term inter-cell mTRP configuration/operation is used to indicate both the inter-cell beam management and inter-cell mTRP related operations.

The terms TCI state and TCI state Identity (ID) are used to refer to the TCI state defined in the NR specifications. In more general terms, this disclosure is applicable to any indication of a DL Beam (beam indication) that indicates to the UE that it needs to monitor a given RS, transmitted in a spatial direction, which can be called a “beam”.

The terms RLM configuration and RLM resource configuration is used interchangeably to refer to reference signals the UE is configured for the purpose of RLM. These may also be called RLM-RS(s).

The terms “active TCI states” and “activated TCI states” mean the same thing.

The methods disclosed are implemented in a UE configured with inter-cell mTRP, where inter-cell multiple mTRP configuration(s) may be provided as any of the approaches/options discussed for inter-cell mTRP/inter-cell beam management in Rel-17 and may also be applicable for Rel-18 solution (in case a different solution is adopted).

In this disclosure (e.g. according to Option 1.cell) for a UE capable of inter-cell mTRP, one cell is considered to be the initial PCell (or current PCell, also referred to as the first cell, or the initial cell, or initial PCell). The first PCell is the cell the UE is camping when the UE performs connection establishment/setup, when transitioning from RRC_IDLE to RRC_CONNECTED, or connection resume, transitioning from RRC_INACTIVE to RRC_CONNECTED, where the first cell has a first PCI associated to that PCell. It is the cell the UE performs random access with, when transitioning to RRC_CONNECTED. In the multi-beam scenario, a cell can be associated to multiple SSBs, and during a half-frame, different SSBs may be transmitted in different spatial directions (i.e. using different beams, spanning the coverage area of a cell). If the UE is configured with MR-DC, i.e., it is configured with a SCG (with an associate PSCell), another cell is the initial PSCell. The first PSCell is the cell the UE accesses when the SCG is added, where in this case the first cell has a first PCI associated to that PSCell. It is the cell the UE performs random access with during SCG addition (also called SN Addition). In the multi-beam scenario, e.g. if the PSCell is in Frequency Range 2 (as defined in TS 38.133), the PSCell can be associated to multiple SSBs, and during a half-frame, different SSBs may be transmitted in different spatial directions (i.e. using different beams, spanning the coverage area of a cell).

In this disclosure (e.g. according to Option 1), the term additional PCell(s) is used to refer to the cells in addition to the PCell from which the UE can perform inter-cell mTRP operation. These are the cells whose RSs are used as QCL of TCI states of the UE's physical channels configurations. They may also be called non-serving cells for mTRP (or inter-cell mTRP), or additional serving cells. If the UE is configured with MR-DC, e.g. according to Option 1, the term additional PSCell(s) is used to refer to the cells in addition to the PSCell from which the UE can perform inter-cell mTRP operation. These are the cells whose RSs are used as QCL of TCI states of the UE's physical channels configurations. They may also be called non-serving cells for mTRP (or inter-cell mTRP), or additional serving cells.

In this disclosure, according to Option 3, a UE has only one PCell and the PCI initially associated to that PCell can be considered as the first cell or initial cell or initial PCell or initial PCI. Using the term cell here is not accurate although possible. Then, similar to above, the additional PCI comes with SSB that is used as QCL of TCI states of the UE's physical channels configurations. They may also be called non-serving cells for inter-cell mTRP or additional serving cells. If the UE is configured with MR-DC, according to Option 3, the UE has only one PSCell and the PCI initially associated to that PSCell can be considered as the first cell or initial cell or initial PSCell or initial PCI. Using the term cell here is not accurate although possible.

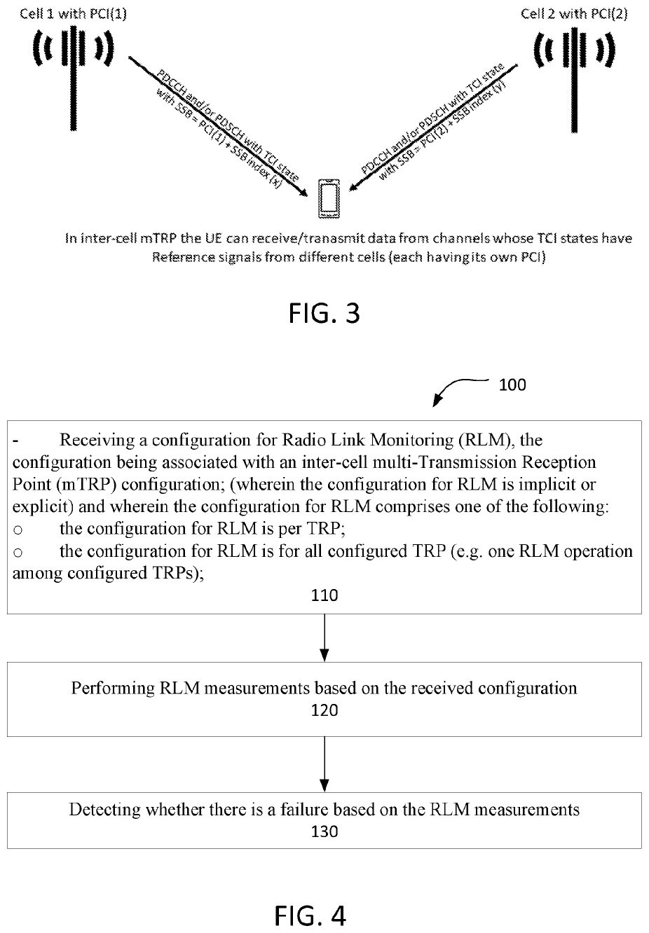

Even though the term “inter-cell mTRP” has the term “inter-cell”, a fundamental aspect is that the UE is configured with physical channels (e.g. PDCCH, PDSCH, PUCCH, PUSCH) whose TCI states (corresponding to DL beam indications for monitoring the channel(s)) may be activated simultaneously, where the TCI states may have reference signals (e.g. SSBs) for its QCL configurations whose PCIs are associated to different cells, as shown in FIG. 3.

A fundamental aspect in these different Options is that the UE is configured with multiple TRPs, where a first TRP has a configured TCI state which has as its QCL source a reference signal from a first cell (or first PCI), and at least one additional TRP has a configured TCI state which has as its QCL source a reference signal from a second cell (or second PCI). In that sense, the disclosure covers different possibilities to configure RLM resources (i.e. reference signals used for RLM), where RSs from the first cell and/or the second cell are used.

The following aspects related to RLM configuration and RLM operation when the UE is configured with the inter-cell mTRP operation will be described:
1) Configuration associated to the RLM configuration;
2) Performing the RLM by the UE; and
3) UE actions upon detecting failure based on the RLM operation.

### 1) RLM Configuration

Solutions described hereinbelow are based on RRC modeling approaches. However, the solutions may also work across RRC modeling approaches or with other RRC modeling approaches not described here.

### A) Explicit RLM Configuration

RLM operation with explicit RLM configuration may be organized as follows:
Option A: the UE is configured and performs RLM operation per TRP:
   a. In RRC modeling Option 1, these TRPs have different PCIs and are modeled as separate serving cell configurations;
   b. In RRC modeling Option 3, these TRPs are within one serving cell configuration and thus these TRPs may share the same PCI or they may have different PCIs.
Option B: the UE performs one RLM operation among TRPs configured:
   a. SUBcase 1: RLM resources may be configured across TRPs and the UE performs one RLM on these resources jointly;
   b. SUBcase 2: RLM resources may be configured per TRP and the UE performs RLM only based on one or selected TRPs jointly;
   c. SUBcase 3: RLM resources are configured only for one TRP and the UE follows and performs RLM only based on those resources.

### Option A: Configuring RLM Independently Per Cell (Option 1) or Per PCI (Option 3) for Per TRP RLM Operation

In one embodiment related to Option 3, the UE receives at least two RLM resource configurations (e.g. RLM-RSs) from the network, one for the serving cell PCI and at least one for an additional PCI. For example, the UE is configured with a list of RLM configurations, each list being associated to a PCI (or cell). Or the UE could be configured with a single list of RLM resources, with each RLM resource configuration within the list having an indication of the cell/PCI the RLM-RS is of.

A couple of examples of how this can be implemented is given below:

| | |
|---|---|
| BWP-DownlinkDedicated ::= | SEQUENCE { |

```
  [...]
      [[
```

| | |
|---|---|
| radioLinkMonitoringConfig-r17 | SEQUENCE (SIZE (1..maxNumInterCellmTRP-r16)) |

RadioLinkMonitoringConfig-r17 OPTIONAL, -- Need M
]]
}

| | |
|---|---|
| RadioLinkMonitoringConfig-r17 ::= | SEQUENCE { |
| aTRPIndex | ATRPIndex, |

radioLinkMonitoringConfig SetupRelease { RadioLinkMonitoringConfig } OPTIONAL -- Need M
}

In the above example, the UE is configured with a list of RLM configuration, where RadioLinkMonitoringConfig is associated to a specific aTRPIndex. The aTRPIndex is equivalent to the CORESETPoolIndex used in grouping CORESETs associated to one TRP. Although it is said that each of these groups of RLM resource configurations may be associated to a different PCI, it is not necessarily so. It is also possible to have RLM resources grouped per, e.g., two TRPs which share the same PCI.

However, if each TRP is associated to a different PCI, one can use the below example and associate the PCI directly to the group or list of RLM resources. Instead of using the original PCI, an index to the PCI may be used. This assumes that PCIs used for this UE for the purpose of inter cell mTRP are listed and indexed in the UEs RRC configuration.

In Option 1, “Each inter-cell lmTRP configuration has its own ServingCellConfig”, thus here one cannot use the BWP-DownlinkDedicated IE conveying RLM configurations for multiple TRPs as this IE is within one ServingCellConfig. In this Option, each TRP has its own BWP-DownlinkDedicated IE and the RLM resource configuration per TRP comes automatically using the existing signalling.

Option B: Configuring RLM for Operating One RLM Per mTRP Configuration (Three Subcases as Shown Below)

### Subcase 1: Configuring RLM Jointly Across Cells (Option 1) or Across PCIs (Option 3)

In an embodiment related to Option 3, the RLM resource configuration is provided as a combination of the RSs from the serving cell PCI and the other PCI. An example of how this can be implemented is given below. In this example, the UE is configured with a list of radioLinkMonitoringRS, where each of the radioLinkMonitoringRS also includes an indication of the PCI associated to this RS.

| | |
|---|---|
| RadioLinkMonitoringConfig ::= | SEQUENCE { |
| failureDetectionResourcesToAddModList | SEQUENCE (SIZE(1..maxNrofFailureDetectionResources)) |

OF RadioLinkMonitoring OPTIONAL, -- Need N

| | |
|---|---|
| failureDetectionResourcesToReleaseList | SEQUENCE (SIZE(1..maxNrofFailureDetectionResources)) |

```
OF RadioLinkMonitoringRS-Id OPTIONAL, -- Need N
  beamFailureInstanceMaxCount ENUMERATED {n1, n2, n3, n4, n5, n6, n8, n10} OPTIONAL, -- Need P
  beamFailureDetectionTimer ENUMERATED {pbfd1, pbfd2, pbfd3, pbfd4, pbfd5, pbfd6, pbfd8,
pbfd10} OPTIONAL, -- Need R
  ...
}
```

| | |
|---|---|
| RadioLinkMonitoringRS ::= | SEQUENCE { |
| radioLinkMonitoringRS-Id | RadioLinkMonitoringRS-Id, |
| purpose | ENUMERATED {beamFailure, rlf, both}, |
| detectionResource | CHOICE { |
| ssb-Index | SSB-Index, |
| csi-RS-Index | NZP-CSI-RS-ResourceId |

```
  },
  ...,
  [[
```

| | | |
|---|---|---|
| rsPCI | PhysCellId | OPTIONAL |

]]

For Option 1, where a UE has independent serving cell configurations, the options can be as follows. The UE still receives the RLM configuration per servingcellconfiguration and thus per TRP, but it is specified that the UE understands these as a single RLM configuration. The other option is that the RLM configuration per servingcellconfig is omitted and a separate RLM configuration is given across the servingcellconfigs, e.g. in cellgroupconfig level.

### Subcase 2: RLM Resources May be Configured Per TRP and UE Performs RLM Only Based on One or Selected TRPs Jointly

In this case, the per TRP configuration can be followed as for the case of independent RLM per TRP but the UE is additionally configured about which TRP the UE should follow. This may be per RRC or there may be a MAC CE that switches the RLM configuration per TRP the UE is considering.

### Subcase 3: RLM Resources are Configured Only for One TRP and UE Follows and Performs RLM Only Based on Those Resources

In one embodiment, the UE receives a RLM resource configuration with one or more RLM resources associated to a single TRP/PCI.

### Additional Considerations: About RLM Configuration Relation to Possible Beam Failure Detection Configuration

It is possible that a UE receives a Beam Failure Detection (BFD) resource configuration per TRP/PCI/Cell in the same IE as the RLM configuration. In a variant, the RLM configuration is separate from the BFD configuration, which may be grouped per TRP but may contain resources across TRPs. In another variant, the RLM resource configuration, in particular the configuration of each RS configured as an RLM-RS, includes an indication of the cell which it refers to, e.g. a PCI or a cell index. The absence of the indication may indicate to the UE that the RS configured for RLM is from the initial PCI/cell. Configuring RLM-RSs only for the initial cell (of a given cell group, e.g. MCG or SCG) is equivalent to operate RLM as no matter how good the quality the UE has in the DL from additional TRPs/cells in inter-cell mTRP operation, what matters from the RLM perspective is the initial cell quality. This makes sense in case the UE operating in inter-cell mTRP uses common channels only from the initial cell, for example.

### B) Implicit RLM Configuration

In one example, if a UE is not configured with explicit RLM or BFD resources, the UE may select from among the active TCI states the resources to follow with a limitation that the resources need to be associated to the main/first PCI.

In another example, if the UE is not configured with explicit RLM resources, the UE may obtain the RSs associated with the active TCI state of PDCCH for performing RLM. When the UE has active TCI states for the PDCCHs, some associated to the serving cell PCI and some associated to the other PCI, the UE uses all of these for performing RLM. The UE may be configured or specified to also select resources associated to only one PCI and the UE may receive RRC or MAC CE signaling to switch the assumption/configuration/indication.

In a variant, the UE's selection of resources, in any of the above cases, is restricted such that it needs to contain X resources associated to the main/first PCI and Y resources associated to the other/second PCI. T

### RLF Related Timers Counters Configuration

In some embodiments, the UE could be configured with a single set of RLF related timers and counters. The UE uses these timers and counters for any RLF related evaluation based on the RLM procedure.

In some other embodiments, the UE could be configured with a PCI specific set of RLF related timers and counters. Some examples of how this can be implemented are given below.

-- Serving cell specific MAC and PHY parameters for a SpCell:

| SpCellConfig ::= | SEQUENCE | |
|---|---|---|
| servCellIndex | ServCellIndex | OPTIONAL, -- Cond SCG |
| reconfigurationWithSync | ReconfigurationWithSync | OPTIONAL, -- Cond ReconfWithSync |
| rlf-TimersAndConstants | SetupRelease { RLF-TimersAndConstants } OPTIONAL, -- Need M | |
| rlmInSyncOutOfSyncThreshold | ENUMERATED {n1} | OPTIONAL, -- Need S |
| spCellConfigDedicated | ServingCellConfig | OPTIONAL, -- Need M |

```
  ...,
  [[
```

| | |
|---|---|
| rlf-TimersAndConstants-r17 | SEQUENCE (SIZE (1..maxNumInterCellmTRP-r16)) Rlf- |

TimersAndConstants-r17 OPTIONAL, -- Need M
]]
}

| | |
|---|---|
| Rlf-TimersAndConstants-r17 ::= | SEQUENCE { |

| | |
|---|---|
| aTRPIndex | ATRPIndex, |

rlf-TimersAndConstants SetupRelease { RLF-TimersAndConstants } OPTIONAL -- Need M
}

In the above example, the UE is configured with a list of RLF timers and counters configuration, where each Rlf-TimersAndConstants is associated to a specific aTRPIndex. The aTRPIndex points at the assistant PCI towards which the UE has a TCI state configuration and this PCI is different from the serving cell PCI. Note that two TRPINdexes may also share the same PCI. When the UE receives a MAC CE indicating the activation of a TCI state for which the QCL source is associated to a different PCI than the serving cell PCI, then the UE starts using the RLF related timers and counters based on the corresponding PCI's radioLinkMonitoringConfig. The mapping between the PCI to the aTRPIndex is also provisioned to the UE.

-- Serving cell specific MAC and PHY parameters for a SpCell:

| SpCellConfig ::= | SEQUENCE { | |
|---|---|---|
| servCellIndex | ServCellIndex | OPTIONAL, -- Cond SCG |
| reconfigurationWithSync | ReconfigurationWithSync | OPTIONAL, -- Cond ReconfWithSync |
| rlf-TimersAndConstants | SetupRelease { RLF-TimersAndConstants } OPTIONAL, -- Need M | |
| rlmInSyncOutOfSyncThreshold | ENUMERATED {n1} | OPTIONAL, -- Need S |
| spCellConfigDedicated | ServingCellConfig | OPTIONAL, -- Need M |

```
  ...,
  [[
```

| | |
|---|---|
| rlf-TimersAndConstantsList-r17 | SEQUENCE (SIZE (1..maxNumInterCellmTRP-r16)) Rlf- |

TimersAndConstants-r17 OPTIONAL, -- Need M
]]
}

| | |
|---|---|
| Rlf-TimersAndConstants-r17 ::= | SEQUENCE { |

| | |
|---|---|
| aCellPCI | PhysCellId, |
| rlf-TimersAndConstants | SetupRelease { RLF-TimersAndConstants } OPTIONAL -- Need M |

}

In the just above example, the UE is configured with a list of RLF related timers and counters' configuration, where each Rlf-TimersAndConstants is associated to a specific PCI. The PCI points at the assistant PCI towards which the UE has a TCI state configuration and this PCI is different from the serving cell PCI. When the UE receives a MAC CE indicating the activation of a TCI state for which the QCL source is associated to a different PCI than the serving cell PCI, then the UE starts using the RLF related timers and counters based on the corresponding PCI's Rlf-TimersAndConstants.

### 2) RLM Operation by the UE

The disclosure proposes methods to be performed by the UE that indicate how to perform the RLM when the UE is configured with the inter-cell mTRP operation. The method includes one or more of the following ways to perform the RLM operation. As RLM operation is under assumption of specific RLM resource configurations, the following examples illustrate the RLM operation based on different RLM resource configurations.

### With Explicit RLM Configuration

Option I: Performing RLM individually based on the RSs as configured:
With RLM RS configuration with RRC Option 1, there is an individual RLM process per cell running in the UE.
With RLM RS configuration with RRC Option 3, there is an individual RLM process per TRP within the cell. Note that the TRPs may have the same or different PCIs.
Timers and counters are per TRP and those are operated per TRP as currently is done per cell.

Option II. a UE performs one RLM among TRPs configured:
Subcase I: RLM resources may be configured across TRPs and the UE performs one RLM on these resources jointly;
Subcase II: RLM resources may be configured per TRP and the UE performs RLM only based on selected TRP(s);
Subcase III: RLM resources are configured only for one TRP and the UE follows and performs RLM only based on those resources.

More specifically, regarding Subcase I: Performing RLM jointly based on the RSs as configured in the RadioLinkMonitoringConfig:
a. With RLM RS configuration with Option 1, a UE needs to perform RLM across cells, which means across RLM RSs configured in each servinghcellConfig;
b. With RLM RS configuration with Option 3, where both the serving cell PCI related RSs and other PCI related RSs can be configured, i.e., there is a combined RLM based on RSs from the serving cell PCI and the other PCI.

Here the term ‘performing RLM jointly’ means that the operation of in-sync and out-of-sync notification sent by the lower layers of the UE is based on the RSs of the TRPs, independent of the RRC modeling Option. The UE's lower layers send an in-sync notification to the upper layers, when at least one of the configured RSs for RLM, belonging to any of the TRPs associated to a currently active TCI state, is better than the threshold Qᵢₙ. And the UE's lower layers send an out-of-sync notification to the upper layers, when all of the configured RSs for RLM, belonging to the serving cell PCI and belonging to PCI associated to the activated TCI state, are worse than the threshold Qₒᵤₜ.

With this option, the UE has one set of RLF timers and counters for the mTRP configuration and applies those as per single serving cell (PCell).

More specifically, regarding Subcase II: Performing RLM on selected TRPs:

With RRC modeling Option 3 or 1, if separately indicated by RRC or MAC CE, the UE may also perform the RLM on selected TRPs, regardless of if more TRPs than the selected ones are configured with RLM resources. There may also be a MAC CE changing the selection on which TRPs the UE performs the RLM.

More specifically, regarding Subcase III: Performing RLM on selected TRPs as RLM resources configured only on selected TRP:
a. With RRC modeling Option 3, performing RLM based on the RSs as configured in the RadioLinkMonitoringConfig, where only the serving cell PCI related RSs can be configured. Here, the UE's lower layers send the OOS indication when none of the RSs configured in the RadioLinkMonitoringConfig is above Qₒᵤₜ threshold and the UE's lower layers send the IS indication when at least one of the RSs configured in the RadioLinkMonitoringConfig is above the Qin threshold.
b. With RRC modeling Option 1, RRC may directly configure RLM resources only on those TRPs where the UE performs the RLM.

For handling the timers and counters in this case, a few options exist. The UE may keep individual counters and timers per TRP and count those and keep timers running only when the UE is performing RLM on those TRPs. The UE may pause the timers and keep the value of counters when the UE is not performing RLM on a given TRP. Alternatively, the UE can stop and reset the timers and clear the counters when the UE stops performing RLM on a given TRP.

### With Implicit Configuration

With this configuration, the UE performs RLM based on the RS(s) associated to the active TCI state of the PDCCH associated to the serving cell PCI.

The UE can also perform RLM jointly based on the RS(s) associated to the active TCI state of the PDCCH associated to the serving cell PCI and the RSs associated to the active TCI state of the PDCCH associated to the other PCI. Here the term ‘performing RLM jointly’ means that the operation of in-sync and out-of-sync notification sent by the lower layers of the UE is based on the RSs of both the serving cell PCI and the other PCI, i.e., the UE's lower layers send an in-sync notification to the upper layers, when at least the RS associated to the activated TCI state for PDCCH of the serving cell PCI or the RS associated to the activated TCI state for PDCCH of the other PCI is better than the Qin threshold and the UE's lower layers send an out-of-sync notification to the upper layers, when none of the RS associated to the activated TCI state for PDCCH of the serving cell PCI or the RS associated to the activated TCI state for PDCCH of the other PCI is better than the Qout threshold.

The UE can also perform RLM individually based on the RS(s) associated to the active TCI state of the PDCCH associated to the serving cell PCI and the RSs associated to the active TCI state of the PDCCH associated to the other PCI, i.e., the RLM based on RS of the activated TCI state for PDCCH of the serving cell PCI is performed independently of the RLM based on RS of the activated TCI state for PDCCH of the other PCI. There are two simultaneous RLM processes running at the UE.

The UE can perform RLM based on any combinations of the above.

### 3) UE Actions Upon Detecting Failure Based on the RLM Operation

The disclosure also proposes methods performed by the UE based on the RLM operation, while the UE is being configured with the inter-cell mTRP operation. A method includes one or more ways associated to the RLF handling based on the RLM operation as follows:
Declare RLF when the RLM associated to the serving cell PCI meets the criterion associated to failure declaration based on N310 counter and T310 timer.
Declare RLF when the RLM associated to the serving cell PCI and the other PCI meets the criterion associated to failure declaration based on N310 counter and T310 timer.
Declare ‘other PCI link failure’ on the other PCI, when the RLM associated to the other PCI meets the criterion associated to failure declaration based on N310 counter and T310 timer configured for the said other PCI.
Any combinations of the above.

The disclosure also proposes methods performed by the UE upon detecting failures based on the RLM operation, while the UE is being configured with the inter-cell mTRP operation.

The method includes one or more of the following ways associated to the failure handling based on the RLM operation:
Upon declaring RLF on the serving cell PCI, performing the re-establishment procedure or the UE initiates the MCG failure recovery procedure by sending the MCGFailureInformation to the Secondary/Slave node (SN).
Upon declaring RLF on the other PCI, transmitting the SCGFailureInformation to the Master Node (MN).
Upon declaring ‘other PCI link failure’, sending an indication to the network node indicating the link failure declaration based on N310 counter and T310 timer configured for the said other PCI. In some examples, this notification is sent via an RRC message or via MAC.

In some examples, where the UE is configured with RLM resources on both TRP, upon declaring ‘other PCI link failure’ alone, the UE sends an indication to the network node to indicate other PCI link failure detection based on the N310 counter and T310 timer configured for the said other PCI.

The UE shall send CSI report containing at least L1-RSRP (of the other PCI) to the network node upon ‘other PCI link failure’ detection.

In some examples, the UE shall send a Scheduling Request (SR) MAC CE containing the beam failure information and target beam information (of the other PCI) to the network node after ‘other PCI link failure’ detection.

Now turning to FIG. 4, a method 100 for RLM in a wireless device configured with inter-cell mTRP operation will be described. Method 100 comprises:

Step 110: Receiving a configuration for RLM, the configuration being associated with an inter-cell mTRP configuration; wherein the configuration for RLM comprises one of the following:
the configuration for RLM is per TRP;
the configuration for RLM is for all configured TRP (e.g. one RLM operation among configured TRPs);

Step 120: Performing RLM measurements based on the received configuration;

Step 130: Detecting whether there is a failure based on the RLM measurements.

It should be noted that the configuration for RLM may be implicit or explicit.

In some examples, when the configuration for RLM is explicit and is per TRP, the mTRP configuration may comprise TRPs that have different PCIs or TRPs that share a same PCI.

In some examples, when the configuration for RLM is explicit and is for all configured TRPs, the configuration for RLM may comprise RLM resources configured across TRPs and performing the RLM measurements may comprise performing one RLM on the configured RLM resources jointly. In some examples, when the configuration for RLM is explicit and is for all configured TRPs, the configuration for RLM may comprise RLM resources configured per TRP and performing the RLM measurements may comprise performing one RLM on one or more selected TRPs jointly. In some examples, when the configuration for RLM is explicit and is for all configured TRPs, the configuration for RLM may comprise RLM resources configured for only one TRP and performing the RLM measurements may comprise performing one RLM only the configured RLM resources for the only one TRP. In some examples, the configuration for RLM per TRP may comprise a configuration per cell or per PCI. In some examples, the configuration for RLM may comprise a combination of resources from a serving cell having a first PCI and another cell having a second PCI. In some examples, the configuration for RLM may comprise a BFD configuration. In some examples, when the configuration for RLM is implicit, the configuration for RLM may be provided by resources associated with active TCI states. In some examples, when the configuration for RLM is implicit, the configuration for RLM may be provided by reference signals associated with active TCI states of PDCCH. In some examples, the UE may receive/obtain a configuration for RLF. In some examples, the configuration for RLF may comprise a set of timers and counters (e.g. specific to a PCI/TRP). In some examples, the UE may perform the RLM measurements across cells. In some examples, performing the RLM measurements may comprise performing RLM measurements jointly based on the reference signals associated with the active TCI states of the PDCCH associated with a serving cell having a first PCI and reference signals associated with active TCI states of a PDCCH associated with another PCI. In some examples, performing the RLM measurements may comprise performing RLM measurements individually based on the reference signals associated with the active TCI states of the PDCCH associated with serving cell PCI and reference signals associated with active TCI states of a PDCCH associated with another PCI (i.e., the RLM based on RS of the activated TCI state for PDCCH of the serving cell PCI is performed independently of the RLM based on RS of the activated TCI state for PDCCH of the other PCI). In some examples, detecting whether there is a failure based on the RLM measurements may comprise declaring RLF when the RLM measurements associated with a serving cell PCI meets a criterion associated with failure declaration based on a counter (e.g. N310) and timer (e.g. T310). In some examples, detecting whether there is a failure based on the RLM measurements may comprise declaring RLF when the RLM measurements associated to a serving cell PCI and another PCI meets a criterion associated to failure declaration based on a counter (e.g. N310) and timer (e.g. T310). In some examples, detecting whether there is a failure based on the RLM measurements may comprise declaring ‘other PCI link failure’ on an additional PCI, when the RLM measurement associated to the additional PCI meets a criterion associated to failure declaration based on a counter (e.g. N310) and a timer (e.g. T310) configured for the additional PCI. In some examples, the UE may perform a re-establishment procedure or a MCG failure recovery procedure. In some examples, the UE may, in response to declaring RLF on the other PCI, transmit a SCGFailureInformation to a Master Node (MN). In some examples, the UE may, in response to declaring ‘other PCI link failure’ on the additional PCI, transmit an indication to a network node indicating the link failure declaration based on the timer and counter configured for the additional PCI.

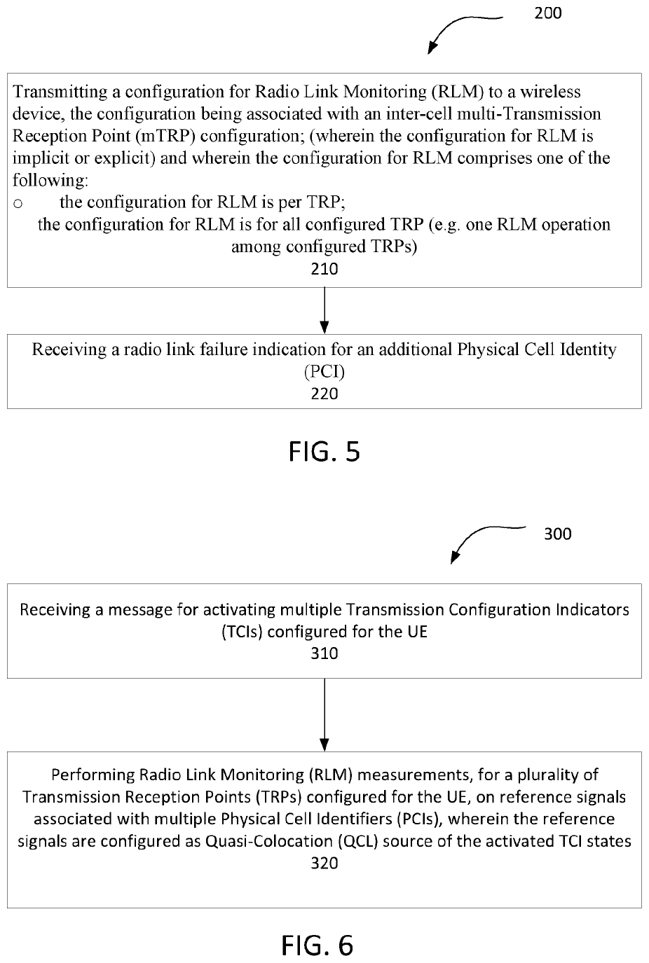

FIG. 5 illustrates a method 200 in a network node for configuring RLM at a wireless device/UE. Method 200 comprises:

Step 210: Transmitting a configuration for RLM to a wireless device, the configuration being associated with an inter-cell mTRP configuration; wherein the configuration for RLM comprises one of the following:
the configuration for RLM is per TRP;
the configuration for RLM is for all configured TRP (e.g. one RLM operation among configured TRPs)

Step 220: Receiving a RLF indication for an additional Physical Cell Identity (PCI).

In some examples, the network node may receive a CSI report. In some examples, the configuration for RLM may be implicit or explicit.

FIG. 6 illustrates a flow chart of a method 300 in a UE, in the context of mTRP operation. As such, the UE is configured with mTRPs. Also, the UE is configured with a plurality of TCI configurations. Method 300 comprises:

Step 310: Receiving a message for activating multiple TCIs configured for the UE;

Step 320: Performing RLM measurements, for a plurality of TRPs configured for the UE, on reference signals associated with multiple PCIs, wherein the reference signals are configured as Quasi-Colocation (QCL) source of the activated TCI states.

For example, this case may correspond to the implicit RLM configuration case.

In some examples, the RSs are associated with a PCI of a serving cell and one or more additional PCI.

In some examples, the UE may obtain a configuration for Radio Link Failure (RLF).

In some examples, the configuration for RLF comprises a set of timers and counters.

In some examples, the set of timers and counters are configured for the multiple PCIs. Or they can be configured for one PCI of the multiple PCIs.

In some examples, performing RLM measurements jointly can be done based jointly on reference signals associated with an activated TCI state associated with a serving cell having a first PCI and reference signals associated with an activated TCI state associated with a second PCI.

In some examples, performing RLM measurements individually may be done based individually on reference signals associated with one or more activated TCI states associated with a serving cell having a first PCI and reference signals associated with activated TCI states associated with a second PCI.

In some examples, the UE may further detect whether there is a failure based on the RLM measurements. In some examples, wherein detecting whether there is a failure based on the RLM measurements may comprise declaring RLF when the RLM measurements associated with a serving cell having a first PCI meets a criterion associated with failure declaration based on a counter and a timer.

In some examples, wherein detecting whether there is a failure based on the RLM measurements may comprise declaring RLF when the RLM measurements associated to a serving cell having a first PCI and a second PCI meet a criterion associated to failure declaration based on a counter and timer. In some examples, detecting whether there is a failure based on the RLM measurements may comprise declaring a PCI link failure on a second PCI, different from a first PCI of a serving cell, when the RLM measurements associated with the second PCI meet a criterion associated to failure declaration based on a counter and a timer configured for the second PCI.

In some examples, the UE may perform a re-establishment procedure or a MCG failure recovery procedure. In some examples, in response to declaring RLF on the second PCI, the UE may transmit failure information to a Master Node (MN). In some examples, in response to declaring a PCI link failure on the second PCI, the UE may transmit an indication to a network node indicating the link failure declaration based on the timer and counter configured for the second PCI.

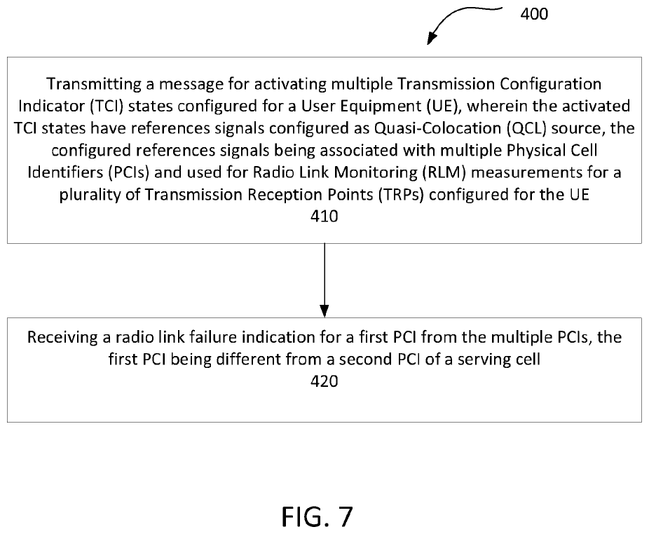

FIG. 7 illustrates a flow chart of a method 400 in a network node communicating with a UE, in the context of mTRP operation. As such, the UE is configured with mTRPs. Also, the UE is configured with a plurality of TCI configurations. Method 400 comprises:

Step 410: Transmitting a message for activating multiple TCI states configured for a UE, wherein the activated TCI states have references signals configured as QCL source, the configured references signals being associated with multiple PCIs and used for RLM measurements for a plurality of TRPs configured for the UE;

Step 420: Receiving a radio link failure indication for a first PCI from the multiple PCIs, the first PCI being different from a second PCI of a serving cell.

In some examples, the network node may receive a CSI report. In some examples the reference signals are associated with the second PCI of the serving cell and one or more additional PCI. In some examples, the network node may transmit a configuration for RLF.

In some examples, the configuration for RLF may comprise a set of timers and counters. In some examples the set of timers and counters are configured for the multiple PCIs.or they can be configured for one PCI of the multiple PCIs.

In some examples, the network node may receive a radio link failure indication for the second PCI of the serving cell.

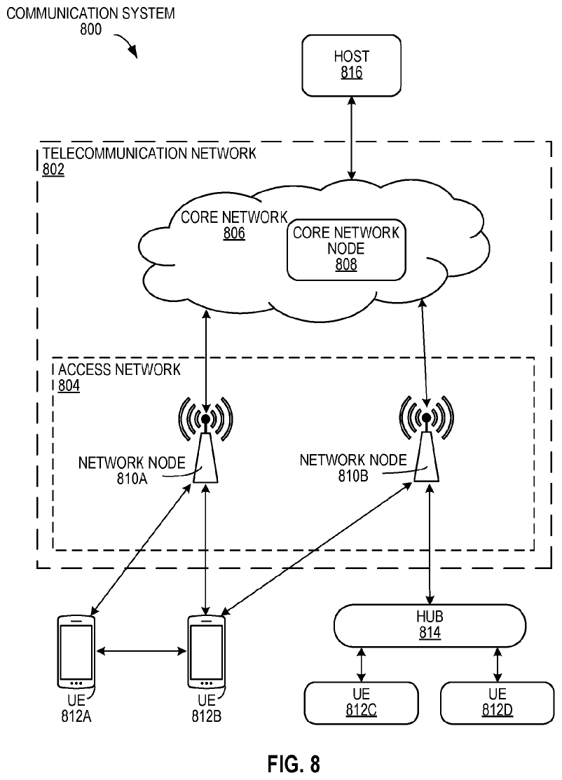

FIG. 8 shows an example of a communication system 800 according to an embodiment.

In the example, the communication system 800 includes a telecommunication network 802 that includes an access network 804, such as a radio access network (RAN), and a core network 806, which includes one or more core network nodes 808. The access network 804 includes one or more access network nodes, such as network nodes 810a and 810b (one or more of which may be generally referred to as network nodes 810), or any other similar 3rd Generation Partnership Project (3GPP) access node or non-3GPP access point. The network nodes 810 facilitate direct or indirect connection of UE, such as by connecting UEs 812a, 812b, 812c, and 812d (one or more of which may be generally referred to as UEs 812) to the core network 806 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 800 may include any number of wired or wireless networks, network nodes, UEs, and/or any other components or systems that may facilitate or participate in the communication of data and/or signals whether via wired or wireless connections. The communication system 800 may include and/or interface with any type of communication, telecommunication, data, cellular, radio network, and/or other similar type of system.

The UEs 812 may be any of a wide variety of communication devices, including wireless devices arranged, configured, and/or operable to communicate wirelessly with the network nodes 810 and other communication devices. Similarly, the network nodes 810 are arranged, capable, configured, and/or operable to communicate directly or indirectly with the UEs 812 and/or with other network nodes or equipment in the telecommunication network 802 to enable and/or provide network access, such as wireless network access, and/or to perform other functions, such as administration in the telecommunication network 802.

In the depicted example, the core network 806 connects the network nodes 810 to one or more hosts, such as host 816. These connections may be direct or indirect via one or more intermediary networks or devices. In other examples, network nodes may be directly coupled to hosts. The core network 806 includes one more core network nodes (e.g., core network node 808) that are structured with hardware and software components. Features of these components may be substantially similar to those described with respect to the UEs, network nodes, and/or hosts, such that the descriptions thereof are generally applicable to the corresponding components of the core network node 808. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 816 may be under the ownership or control of a service provider other than an operator or provider of the access network 804 and/or the telecommunication network 802, and may be operated by the service provider or on behalf of the service provider. The host 816 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 800 of FIG. 8 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 802 is a cellular network that implements 3GPP standardized features. Accordingly, the telecommunications network 802 may support network slicing to provide different logical networks to different devices that are connected to the telecommunication network 802. For example, the telecommunications network 802 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 812 are configured to transmit and/or receive information without direct human interaction. For instance, a UE may be designed to transmit information to the access network 804 on a predetermined schedule, when triggered by an internal or external event, or in response to requests from the access network 804. Additionally, a UE may be configured for operating in single- or multi-RAT or multi-standard mode. For example, a UE may operate with any one or combination of Wi-Fi, NR and LTE, i.e. being configured for multi-radio dual connectivity (MR-DC), such as E-UTRAN (Evolved-UMTS Terrestrial Radio Access Network) New Radio—Dual Connectivity (EN-DC).

In the example, the hub 814 communicates with the access network 804 to facilitate indirect communication between one or more UEs (e.g., UE 812c and/or 812d) and network nodes (e.g., network node 810b). In some examples, the hub 814 may be a controller, router, content source and analytics, or any of the other communication devices described herein regarding UEs. For example, the hub 814 may be a broadband router enabling access to the core network 806 for the UEs. As another example, the hub 814 may be a controller that sends commands or instructions to one or more actuators in the UEs. Commands or instructions may be received from the UEs, network nodes 810, or by executable code, script, process, or other instructions in the hub 814. As another example, the hub 814 may be a data collector that acts as temporary storage for UE data and, in some embodiments, may perform analysis or other processing of the data. As another example, the hub 814 may be a content source. For example, for a UE that is a VR headset, display, loudspeaker or other media delivery device, the hub 814 may retrieve VR assets, video, audio, or other media or data related to sensory information via a network node, which the hub 814 then provides to the UE either directly, after performing local processing, and/or after adding additional local content. In still another example, the hub 814 acts as a proxy server or orchestrator for the UEs, in particular in if one or more of the UEs are low energy IoT devices.

The hub 814 may have a constant/persistent or intermittent connection to the network node 810b. The hub 814 may also allow for a different communication scheme and/or schedule between the hub 814 and UEs (e.g., UE 812c and/or 812d), and between the hub 814 and the core network 806. In other examples, the hub 814 is connected to the core network 806 and/or one or more UEs via a wired connection. Moreover, the hub 814 may be configured to connect to an M2M service provider over the access network 804 and/or to another UE over a direct connection. In some scenarios, UEs may establish a wireless connection with the network nodes 810 while still connected via the hub 814 via a wired or wireless connection. In some embodiments, the hub 814 may be a dedicated hub—that is, a hub whose primary function is to route communications to/from the UEs from/to the network node 810b. In other embodiments, the hub 814 may be a non-dedicated hub—that is, a device which is capable of operating to route communications between the UEs and network node 810b, but which is additionally capable of operating as a communication start and/or end point for certain data channels.

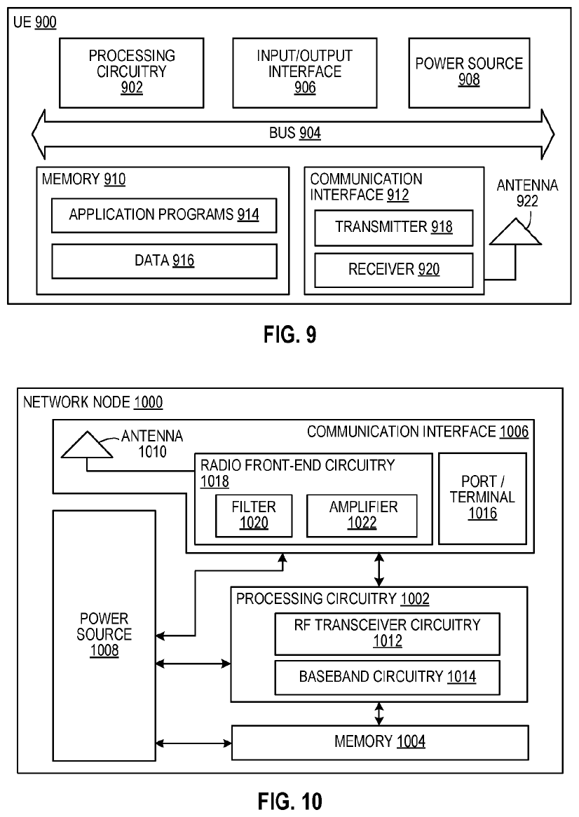

FIG. 9 shows a UE 900 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VoIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3GPP, including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 900 includes processing circuitry 902 that is operatively coupled via a bus 904 to an input/output interface 906, a power source 908, a memory 910, a communication interface 912, and/or any other component, or any combination thereof. Certain UEs may utilize all or a subset of the components shown in FIG. 9. The level of integration between the components may vary from one UE to another UE. Further, certain UEs may contain multiple instances of a component, such as multiple processors, memories, transceivers, transmitters, receivers, etc.

The processing circuitry 902 is configured to process instructions and data and may be configured to implement any sequential state machine operative to execute instructions stored as machine-readable computer programs in the memory 910. The processing circuitry 902 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 902 may include multiple central processing units (CPUs).

In the example, the input/output interface 906 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 900. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 908 is structured as a battery or battery pack. Other types of power sources, such as an external power source (e.g., an electricity outlet), photovoltaic device, or power cell, may be used. The power source 908 may further include power circuitry for delivering power from the power source 908 itself, and/or an external power source, to the various parts of the UE 900 via input circuitry or an interface such as an electrical power cable. Delivering power may be, for example, for charging of the power source 908. Power circuitry may perform any formatting, converting, or other modification to the power from the power source 908 to make the power suitable for the respective components of the UE 900 to which power is supplied.

The memory 910 may be or be configured to include memory such as random access memory (RAM), read-only memory (ROM), programmable ROM (PROM), erasable ROM (EPROM), electrically erasable programmable ROM (EEPROM), magnetic disks, optical disks, hard disks, removable cartridges, flash drives, and so forth. In one example, the memory 910 includes one or more application programs 914, such as an operating system, web browser application, a widget, gadget engine, or other application, and corresponding data 916. The memory 910 may store, for use by the UE 900, any of a variety of various operating systems or combinations of operating systems.

The memory 910 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory 910 may allow the UE 900 to access instructions, application programs and the like, stored on transitory or non-transitory memory media, to off-load data, or to upload data. An article of manufacture, such as one utilizing a communication system may be tangibly embodied as or in the memory 910, which may be or comprise a device-readable storage medium.

The processing circuitry 902 may be configured to communicate with an access network or other network using the communication interface 912. The communication interface 912 may comprise one or more communication subsystems and may include or be communicatively coupled to an antenna 922. The communication interface 912 may include one or more transceivers used to communicate, such as by communicating with one or more remote transceivers of another device capable of wireless communication (e.g., another UE or a network node in an access network). Each transceiver may include a transmitter 918 and/or a receiver 920 appropriate to provide network communications (e.g., optical, electrical, frequency allocations, and so forth). Moreover, the transmitter 918 and receiver 920 may be coupled to one or more antennas (e.g., antenna 922) and may share circuit components, software or firmware, or alternatively be implemented separately. Furthermore, the processing circuitry 902 is configured to perform any of the steps of 100 of FIG. 4 and method 300 of FIG. 6.

In the illustrated embodiment, communication functions of the communication interface 912 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 912, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 900 shown in FIG. 9.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g. by controlling an actuator) to increase or decrease the drone's speed. The first and/or the second UE can also include more than one of the functionalities described above. For example, a UE might comprise the sensor and the actuator, and handle communication of data for both the speed sensor and the actuators.

FIG. 10 shows a network node 1000 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NBs (gNBs)).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 1000 includes a processing circuitry 1002, a memory 1004, a communication interface 1006, and a power source 1008. The network node 1000 may be composed of multiple physically separate components (e.g., a NodeB component and a RNC component, or a BTS component and a BSC component, etc.), which may each have their own respective components. In certain scenarios in which the network node 1000 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 1000 may be configured to support multiple radio access technologies (RATs). In such embodiments, some components may be duplicated (e.g., separate memory 1004 for different RATs) and some components may be reused (e.g., a same antenna 1010 may be shared by different RATs). The network node 1000 may also include multiple sets of the various illustrated components for different wireless technologies integrated into network node 1000, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 1000.

The processing circuitry 1002 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 1000 components, such as the memory 1004, to provide network node 1000 functionality.

In some embodiments, the processing circuitry 1002 includes a system on a chip (SOC). In some embodiments, the processing circuitry 1002 includes one or more of radio frequency (RF) transceiver circuitry 1012 and baseband processing circuitry 1014. In some embodiments, the radio frequency (RF) transceiver circuitry 1012 and the baseband processing circuitry 1014 may be on separate chips (or sets of chips), boards, or units, such as radio units and digital units. In alternative embodiments, part or all of RF transceiver circuitry 1012 and baseband processing circuitry 1014 may be on the same chip or set of chips, boards, or units. Furthermore, the processing circuitry 1002 is configured to perform any of the steps of method 200 of FIG. 5 and method 400 of FIG. 7.

The memory 1004 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 1002. The memory 1004 may store any suitable instructions, data, or information, including a computer program, software, an application including one or more of logic, rules, code, tables, and/or other instructions capable of being executed by the processing circuitry 1002 and utilized by the network node 1000. The memory 1004 may be used to store any calculations made by the processing circuitry 1002 and/or any data received via the communication interface 1006. In some embodiments, the processing circuitry 1002 and memory 1004 is integrated.

The communication interface 1006 is used in wired or wireless communication of signaling and/or data between a network node, access network, and/or UE. As illustrated, the communication interface 1006 comprises port(s)/terminal(s) 1016 to send and receive data, for example to and from a network over a wired connection. The communication interface 1006 also includes radio front-end circuitry 1018 that may be coupled to, or in certain embodiments a part of, the antenna 1010. Radio front-end circuitry 1018 comprises filters 1020 and amplifiers 1022. The radio front-end circuitry 1018 may be connected to an antenna 1010 and processing circuitry 1002. The radio front-end circuitry may be configured to condition signals communicated between antenna 1010 and processing circuitry 1002. The radio front-end circuitry 1018 may receive digital data that is to be sent out to other network nodes or UEs via a wireless connection. The radio front-end circuitry 1018 may convert the digital data into a radio signal having the appropriate channel and bandwidth parameters using a combination of filters 1020 and/or amplifiers 1022. The radio signal may then be transmitted via the antenna 1010. Similarly, when receiving data, the antenna 1010 may collect radio signals which are then converted into digital data by the radio front-end circuitry 1018. The digital data may be passed to the processing circuitry 1002. In other embodiments, the communication interface may comprise different components and/or different combinations of components.

In certain alternative embodiments, the network node 1000 does not include separate radio front-end circuitry 1018, instead, the processing circuitry 1002 includes radio front-end circuitry and is connected to the antenna 1010. Similarly, in some embodiments, all or some of the RF transceiver circuitry 1012 is part of the communication interface 1006. In still other embodiments, the communication interface 1006 includes one or more ports or terminals 1016, the radio front-end circuitry 1018, and the RF transceiver circuitry 1012, as part of a radio unit (not shown), and the communication interface 1006 communicates with the baseband processing circuitry 1014, which is part of a digital unit (not shown).

The antenna 1010 may include one or more antennas, or antenna arrays, configured to send and/or receive wireless signals. The antenna 1010 may be coupled to the radio front-end circuitry 1018 and may be any type of antenna capable of transmitting and receiving data and/or signals wirelessly. In certain embodiments, the antenna 1010 is separate from the network node 1000 and connectable to the network node 1000 through an interface or port.

The antenna 1010, communication interface 1006, and/or the processing circuitry 1002 may be configured to perform any receiving operations and/or certain obtaining operations described herein as being performed by the network node. Any information, data and/or signals may be received from a UE, another network node and/or any other network equipment. Similarly, the antenna 1010, the communication interface 1006, and/or the processing circuitry 1002 may be configured to perform any transmitting operations described herein as being performed by the network node. Any information, data and/or signals may be transmitted to a UE, another network node and/or any other network equipment.

The power source 1008 provides power to the various components of network node 1000 in a form suitable for the respective components (e.g., at a voltage and current level needed for each respective component). The power source 1008 may further comprise, or be coupled to, power management circuitry to supply the components of the network node 1000 with power for performing the functionality described herein. For example, the network node 1000 may be connectable to an external power source (e.g., the power grid, an electricity outlet) via an input circuitry or interface such as an electrical cable, whereby the external power source supplies power to power circuitry of the power source 1008. As a further example, the power source 1008 may comprise a source of power in the form of a battery or battery pack which is connected to, or integrated in, power circuitry. The battery may provide backup power should the external power source fail.

Embodiments of the network node 1000 may include additional components beyond those shown in FIG. 10 for providing certain aspects of the network node's functionality, including any of the functionality described herein and/or any functionality necessary to support the subject matter described herein. For example, the network node 1000 may include user interface equipment to allow input of information into the network node 1000 and to allow output of information from the network node 1000. This may allow a user to perform diagnostic, maintenance, repair, and other administrative functions for the network node 1000.

FIG. 11 is a block diagram of a host 1100, which may be an embodiment of the host 816 of FIG. 8, in accordance with various aspects described herein. As used herein, the host 1100 may be or comprise various combinations hardware and/or software, including a standalone server, a blade server, a cloud-implemented server, a distributed server, a virtual machine, container, or processing resources in a server farm. The host 1100 may provide one or more services to one or more UEs.

The host 1100 includes processing circuitry 1102 that is operatively coupled via a bus 1104 to an input/output interface 1106, a network interface 1108, a power source 1110, and a memory 1112. Other components may be included in other embodiments. Features of these components may be substantially similar to those described with respect to the devices of previous figures, such as FIGS. 9 and 10, such that the descriptions thereof are generally applicable to the corresponding components of host 1100.

The memory 1112 may include one or more computer programs including one or more host application programs 1114 and data 1116, which may include user data, e.g., data generated by a UE for the host 1100 or data generated by the host 1100 for a UE. Embodiments of the host 1100 may utilize only a subset or all of the components shown. The host application programs 1114 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 1114 may also provide for user authentication and licensing checks and may periodically report health, routes, and content availability to a central node, such as a device in or on the edge of a core network. Accordingly, the host 1100 may select and/or indicate a different host for over-the-top services for a UE. The host application programs 1114 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

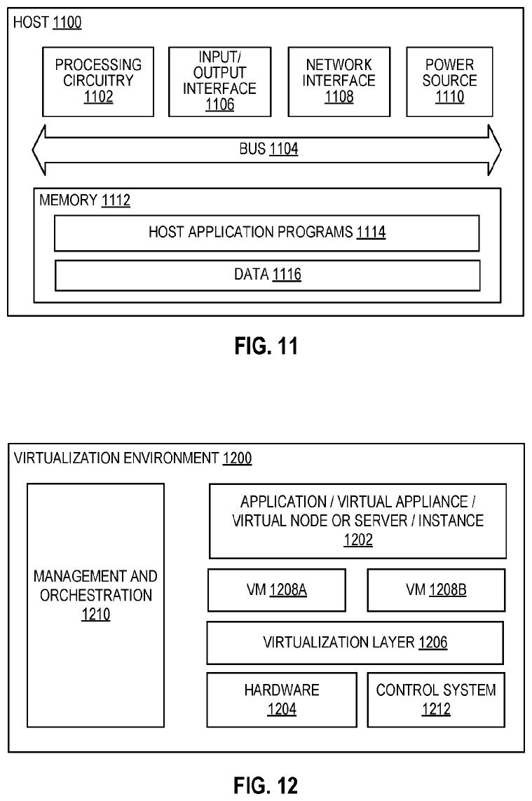

FIG. 12 is a block diagram illustrating a virtualization environment 1200 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 1200 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 1202 (which may alternatively be called software instances, virtual appliances, network functions, virtual nodes, virtual network functions, etc.) are run in the virtualization environment Q400 to implement some of the features, functions, and/or benefits of some of the embodiments disclosed herein.

Hardware 1204 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 1206 (also referred to as hypervisors or virtual machine monitors (VMMs)), provide VMs 1208a and 1208b (one or more of which may be generally referred to as VMs 1208), and/or perform any of the functions, features and/or benefits described in relation with some embodiments described herein. The virtualization layer 1206 may present a virtual operating platform that appears like networking hardware to the VMs 1208.

The VMs 1208 comprise virtual processing, virtual memory, virtual networking or interface and virtual storage, and may be run by a corresponding virtualization layer 1206. Different embodiments of the instance of a virtual appliance 1202 may be implemented on one or more of VMs 1208, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 1208 may be a software implementation of a physical machine that runs programs as if they were executing on a physical, non-virtualized machine. Each of the VMs 1208, and that part of hardware 1204 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 1208 on top of the hardware 1204 and corresponds to the application 1202.

Hardware 1204 may be implemented in a standalone network node with generic or specific components. Hardware 1204 may implement some functions via virtualization. Alternatively, hardware 1204 may be part of a larger cluster of hardware (e.g. such as in a data center or CPE) where many hardware nodes work together and are managed via management and orchestration 1210, which, among others, oversees lifecycle management of applications 1202. In some embodiments, hardware 1204 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 1212 which may alternatively be used for communication between hardware nodes and radio units.

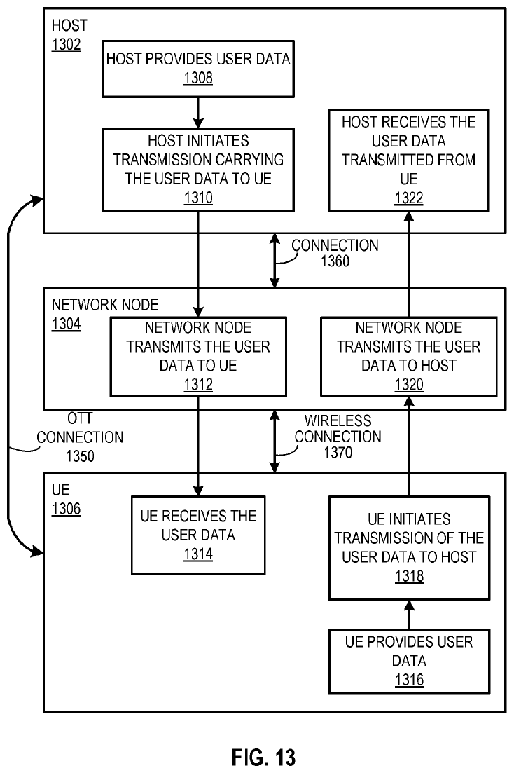

FIG. 13 shows a communication diagram of a host 1302 communicating via a network node 1304 with a UE 1306 over a partially wireless connection in accordance with some embodiments. Example implementations, in accordance with various embodiments, of the UE (such as a UE 812a of FIG. 8 and/or UE 900 of FIG. 9), network node (such as network node 810a of FIG. 8 and/or network node 1000 of FIG. 10), and host (such as host 816 of FIG. 8 and/or host 1100 of FIG. 11) discussed in the preceding paragraphs will now be described with reference to FIG. 13.

Like host 1100, embodiments of host 1302 include hardware, such as a communication interface, processing circuitry, and memory. The host 1302 also includes software, which is stored in or accessible by the host 1302 and executable by the processing circuitry. The software includes a host application that may be operable to provide a service to a remote user, such as the UE 1306 connecting via an over-the-top (OTT) connection 1350 extending between the UE 1306 and host 1302. In providing the service to the remote user, a host application may provide user data which is transmitted using the OTT connection 1350.

The network node 1304 includes hardware enabling it to communicate with the host 1302 and UE 1306. The connection 1360 may be direct or pass through a core network (like core network 806 of FIG. 8) and/or one or more other intermediate networks, such as one or more public, private, or hosted networks. For example, an intermediate network may be a backbone network or the Internet.

The UE 1306 includes hardware and software, which is stored in or accessible by UE 1306 and executable by the UE's processing circuitry. The software includes a client application, such as a web browser or operator-specific “app” that may be operable to provide a service to a human or non-human user via UE 1306 with the support of the host 1302. In the host 1302, an executing host application may communicate with the executing client application via the OTT connection 1350 terminating at the UE 1306 and host 1302. In providing the service to the user, the UE's client application may receive request data from the host's host application and provide user data in response to the request data. The OTT connection 1350 may transfer both the request data and the user data. The UE's client application may interact with the user to generate the user data that it provides to the host application through the OTT connection 1350.

The OTT connection 1350 may extend via a connection 1360 between the host 1302 and the network node 1304 and via a wireless connection 1370 between the network node 1304 and the UE 1306 to provide the connection between the host 1302 and the UE 1306. The connection 1360 and wireless connection 1370, over which the OTT connection 1350 may be provided, have been drawn abstractly to illustrate the communication between the host 1302 and the UE 1306 via the network node 1304, without explicit reference to any intermediary devices and the precise routing of messages via these devices.

As an example of transmitting data via the OTT connection 1350, in step 1308, the host 1302 provides user data, which may be performed by executing a host application. In some embodiments, the user data is associated with a particular human user interacting with the UE 1306. In other embodiments, the user data is associated with a UE 1306 that shares data with the host 1302 without explicit human interaction. In step 1310, the host 1302 initiates a transmission carrying the user data towards the UE 1306. The host 1302 may initiate the transmission responsive to a request transmitted by the UE 1306. The request may be caused by human interaction with the UE 1306 or by operation of the client application executing on the UE 1306. The transmission may pass via the network node 1304, in accordance with the teachings of the embodiments described throughout this disclosure. Accordingly, in step 1312, the network node 1304 transmits to the UE 1306 the user data that was carried in the transmission that the host 1302 initiated, in accordance with the teachings of the embodiments described throughout this disclosure. In step 1314, the UE 1306 receives the user data carried in the transmission, which may be performed by a client application executed on the UE 1306 associated with the host application executed by the host 1302.

In some examples, the UE 1306 executes a client application which provides user data to the host 1302. The user data may be provided in reaction or response to the data received from the host 1302. Accordingly, in step 1316, the UE 1306 may provide user data, which may be performed by executing the client application. In providing the user data, the client application may further consider user input received from the user via an input/output interface of the UE 1306. Regardless of the specific manner in which the user data was provided, the UE 1306 initiates, in step 1318, transmission of the user data towards the host 1302 via the network node 1304. In step 1320, in accordance with the teachings of the embodiments described throughout this disclosure, the network node 1304 receives user data from the UE 1306 and initiates transmission of the received user data towards the host 1302. In step 1322, the host 1302 receives the user data carried in the transmission initiated by the UE 1306.

One or more of the various embodiments improve the performance of OTT services provided to the UE 1306 using the OTT connection 1350, in which the wireless connection 1370 forms the last segment. More precisely, the teachings of these embodiments may improve the data rate, latency, power consumption and thereby provide benefits such as reduced user waiting time, better responsiveness, extended battery lifetime.

In an example scenario, factory status information may be collected and analyzed by the host 1302. As another example, the host 1302 may process audio and video data which may have been retrieved from a UE for use in creating maps. As another example, the host 1302 may collect and analyze real-time data to assist in controlling vehicle congestion (e.g., controlling traffic lights). As another example, the host 1302 may store surveillance video uploaded by a UE. As another example, the host 1302 may store or control access to media content such as video, audio, VR or AR which it can broadcast, multicast or unicast to UEs. As other examples, the host 1302 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection 1350 between the host 1302 and UE 1306, in response to variations in the measurement results. The measurement procedure and/or the network functionality for reconfiguring the OTT connection may be implemented in software and hardware of the host 1302 and/or UE 1306. In some embodiments, sensors (not shown) may be deployed in or in association with other devices through which the OTT connection 1350 passes; the sensors may participate in the measurement procedure by supplying values of the monitored quantities exemplified above, or supplying values of other physical quantities from which software may compute or estimate the monitored quantities. The reconfiguring of the OTT connection 1350 may include message format, retransmission settings, preferred routing etc.; the reconfiguring need not directly alter the operation of the network node 1304. Such procedures and functionalities may be known and practiced in the art. In certain embodiments, measurements may involve proprietary UE signaling that facilitates measurements of throughput, propagation times, latency and the like, by the host 1302. The measurements may be implemented in that software causes messages to be transmitted, in particular empty or ‘dummy’ messages, using the OTT connection 1350 while monitoring propagation times, errors, etc.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

1. A method performed by a user equipment (UE), the method comprising:
Receiving a message for activating multiple Transmission Configuration Indicators (TCIs) configured for the UE; and
Performing Radio Link Monitoring (RLM) measurements, for a plurality of Transmission Reception Points (TRPs) configured for the UE, on reference signals associated with multiple Physical Cell Identifiers (PCIs), wherein the reference signals are configured as Quasi-Colocation (QCL) source of the activated TCI states.

2. The method of claim 1, wherein the reference signals are associated with a PCI of a serving cell and one or more additional PCI.

3. The method of claim 1, further comprising obtaining a configuration for Radio Link Failure (RLF).

4. The method of claim 3, wherein the configuration for RLF comprises a set of timers and counters.

5. The method of claim 4, wherein the set of timers and counters are configured for one PCI of the multiple PCIs or for the multiple PCIs.

6. (canceled)

7. The method of claim 1, wherein performing the RLM measurements comprises performing RLM measurements jointly based on reference signals associated with an activated TCI state associated with a serving cell having a first PCI and reference signals associated with an activated TCI state associated with a second PCI.

8. The method of claim 1, wherein performing the RLM measurements comprises performing RLM measurements individually based on reference signals associated with one or more activated TCI states associated with a serving cell having a first PCI and reference signals associated with activated TCI states associated with a second PCI.

9. The method of claim 1, further comprising detecting whether there is a failure based on the RLM measurements.

10. The method of claim 9, wherein detecting whether there is a failure based on the RLM measurements comprises declaring radio link failure (RLF) when the RLM measurements associated with a serving cell having a first PCI meets a criterion associated with failure declaration based on a counter and a timer.

11. The method of claim 9, wherein detecting whether there is a failure based on the RLM measurements comprises declaring RLF when the RLM measurements associated with a serving cell having a first PCI and a second PCI meet a criterion associated to failure declaration based on a counter and timer.

12. The method of claim 9, wherein detecting whether there is a failure based on the RLM measurements comprises declaring a PCI link failure on a second PCI, different from a first PCI of a serving cell, when the RLM measurements associated with the second PCI meet a criterion associated to failure declaration based on a counter and a timer configured for the second PCI.

13. The method of claim 10, further comprising performing a re-establishment procedure or a Master Cell Group (MCG) failure recovery procedure.

14. (canceled)

15. The method of claim 12, further comprising, in response to declaring a PCI link failure on the second PCI, transmitting an indication to a network node indicating the link failure declaration based on the timer and counter configured for the second PCI.

16. A method in a network node, the method comprising:
Transmitting a message for activating multiple Transmission Configuration Indicator (TCI) states configured for a User Equipment (UE), wherein the activated TCI states have references signals configured as Quasi-Colocation (QCL) source, the configured references signals being associated with multiple Physical Cell Identifiers (PCIs) and used for Radio Link Monitoring (RLM) measurements for a plurality of Transmission Reception Points (TRPs) configured for the UE; and
Receiving a radio link failure indication for a first PCI from the multiple PCIs, the first PCI being different from a second PCI of a serving cell.

17. (canceled)

18. The method of claim 16, wherein the reference signals are associated with the second PCI of the serving cell and one or more additional PCI.

19. The method of claim 16, further comprising transmitting a configuration for Radio Link Failure (RLF).

20. The method of claim 19, wherein the configuration for RLF comprises a set of timers and counters.

21. The method of claim 20, wherein the set of timers and counters are configured for one of the multiple PCIs or for the multiple PCIs.

22. (canceled)

23. The method of claim 16, further comprising receiving a radio link failure indication for the second PCI of the serving cell.

24. A User Equipment (UE) comprising network interfaces and processing circuitry connected thereto, configured to:
receive a message for activating multiple Transmission Configuration Indicators (TCIs) configured for the UE; and
perform Radio Link Monitoring (RLM) measurements, for a plurality of Transmission Reception Points (TRPs) configured for the UE, on reference signals associated with multiple Physical Cell Identifiers (PCIs), wherein the reference signals are configured as Quasi-Colocation (QCL) source of the activated TCI state.

25. (canceled)

26. (canceled)
